(19) United States
(12) Patent Application Publication
(10) Pub. No.: US 2024/0395230 A1
(43) Pub. Date: Nov. 28, 2024

(54) Saddle Attachment System for Bass Drum Carrier

(71) Applicant: Randall May International Incorporated, Irvine, CA (US)

(72) Inventor: Randall L. MAY, Irvine, CA (US)

(21) Appl. No.: 18/674,621

(22) Filed: May 24, 2024

Related U.S. Application Data
(63) Continuation-in-part of application No. 17/985,503, filed on Nov. 11, 2022.
(60) Provisional application No. 63/504,711, filed on May 26, 2023.

(51) Int. Cl. G10G 5/00; G10D 13/10

(52) U.S. Cl. CPC G10G 5/005; G10D 13/28

(57) ABSTRACT

A saddle attachment mechanism for a percussion instrument carrier includes a saddle mount and a receiver. The saddle mount mounts the saddle attachment mechanism to the percussion instrument carrier at a front side thereof and between shoulder straps and a belly plate thereof so as to form an upper anchor point. The receiver is coupled to the saddle mount and receives a percussion instrument mounted grip therein so as to thereby couple the percussion instrument to the carrier such that the percussion instrument is rotatable about an x-axis of the upper anchor point and rests on a support member of the percussion instrument carrier. A vertical adjustment of the support member functions to rotationally adjust the playing position of the percussion instrument about the x-axis of the upper anchor point.

### CROSS REFERENCE TO RELATED APPLICATION

This application claims priority to U.S. Pat. Appl. No. 63/504,711 filed on May 26, 2023, the entire contents and disclosures of which are hereby expressly incorporated by reference.

This application is a continuation-in-part of U.S. patent application Ser. No. 17/985,503 filed on Nov. 11, 2022, the entire contents and disclosures of which are hereby expressly incorporated by reference herein.

### BACKGROUND OF THE INVENTION

This disclosure relates generally to instrument support hardware, and more particularly to saddle attachment systems for marching bass drum instrument carriers.

Percussion instruments are known to be mechanically mounted on support structures, e.g., stands, kit frames, carriers, etc., so that they may be played. In the case of marching bands, it is desirable for bass drums to be removed from personal carriers (i.e., carriers that allow the user to support the bass drum on the user's person in playing position while marching) and subsequently mounted on stands positioned on the ground or other playing surfaces (e.g., bleachers, etc.) so that the user may play the bass drum while it is mounted on the stand. In competitive (and even non-competitive) marching band performances, it is highly desirable to achieve a quick and seamless transition between carrier mounted and stand mounted playing. However, due to the large and heavy nature of the bass drum, and to the complexity of both carrier and stand mounting, such quick and seamless transitions are difficult to achieve.

Furthermore, also due to the large and heavy nature of the bass drum, positioning the bass drum on the carrier itself at an optimal playing position (i.e., a playing position that allows for natural arm movement while playing) is difficult and requires much time to make the necessary adjustments. This difficulty is magnified when bass drums of different sizes are exchanged. Such difficulties lead to performance limitations for the user and the marching band as a whole.

It is therefore desirable to provide advantages over such known systems and methods. Other features and advantages of the present invention will become apparent from the following more detailed description, taken in conjunction with the accompanying drawings, which illustrate, by way of example, the principles of the presently described embodiments.

### BRIEF DESCRIPTION OF THE DRAWINGS

FIGS. 1A-1C illustrate exemplary carriers with saddle attachments in accordance at least one embodiment;

FIG. 2 illustrates an exemplary saddle attachment in accordance with at least one embodiment;

FIGS. 3A-B illustrate exemplary carriers with saddle attachments in accordance with at least one embodiment;

FIG. 4 illustrates an exemplary carrier with saddle attachment in accordance with at least one embodiment;

FIGS SA-5C illustrate exemplary carriers with saddle attachments, in accordance with at least one embodiment;

FIG. 6 illustrates an exemplary saddle attachment in accordance with at least one embodiment;

FIGS. 7A-7B illustrate exemplary carriers with saddle attachments in accordance with at least one embodiment;

FIG. 7C illustrates an exploded view of a saddle attachment and carrier in accordance with at least one embodiment;

FIG. 7D illustrates an exemplary articulating hinge member in accordance with at least one embodiment; and

FIG. 8 illustrates an exemplary carrier with saddle attachment in accordance with at least one embodiment.

### DETAILED DESCRIPTION OF THE PREFERRED EMBODIMENTS

The above described drawing figures illustrate the disclosed invention in at least one embodiment, which is further defined in detail in the following description. Those having ordinary skill in the art may be able to make alterations and modifications to what is described herein without departing from its spirit and scope. While this invention is susceptible of embodiment in many different forms, there is shown in the drawings and will herein be described in detail a preferred embodiment of the invention with the understanding that the present disclosure is to be considered as an exemplification of the principles of the invention and is not intended to limit the broad aspects of the invention to any embodiment illustrated. Therefore, it should be understood that what is illustrated is set forth only for the purposes of example and should not be taken as a limitation on the scope of the disclosed invention.

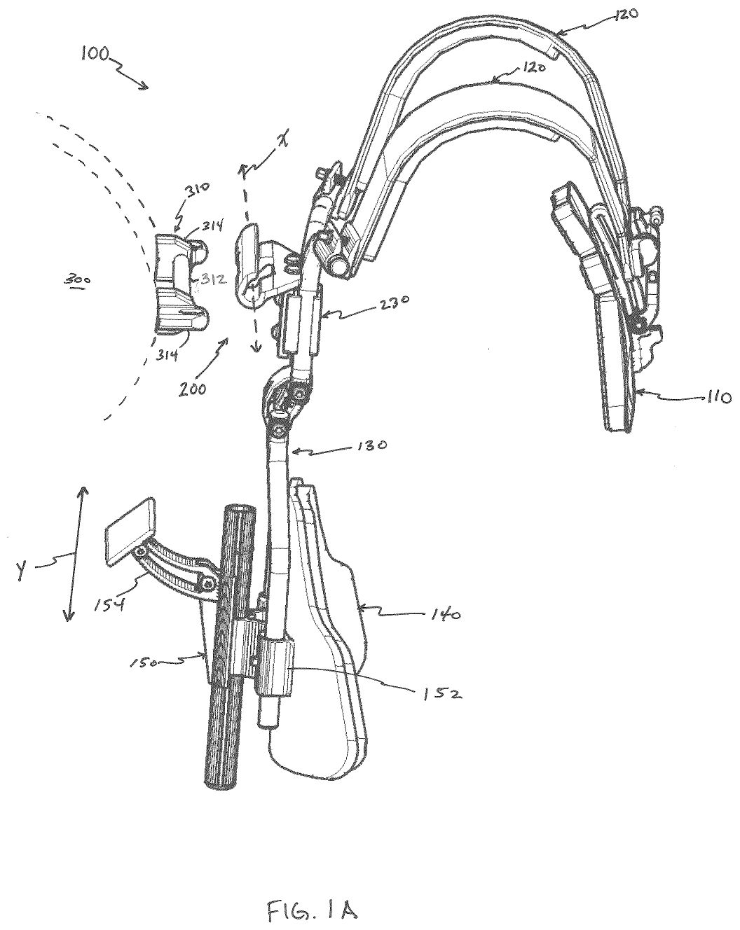

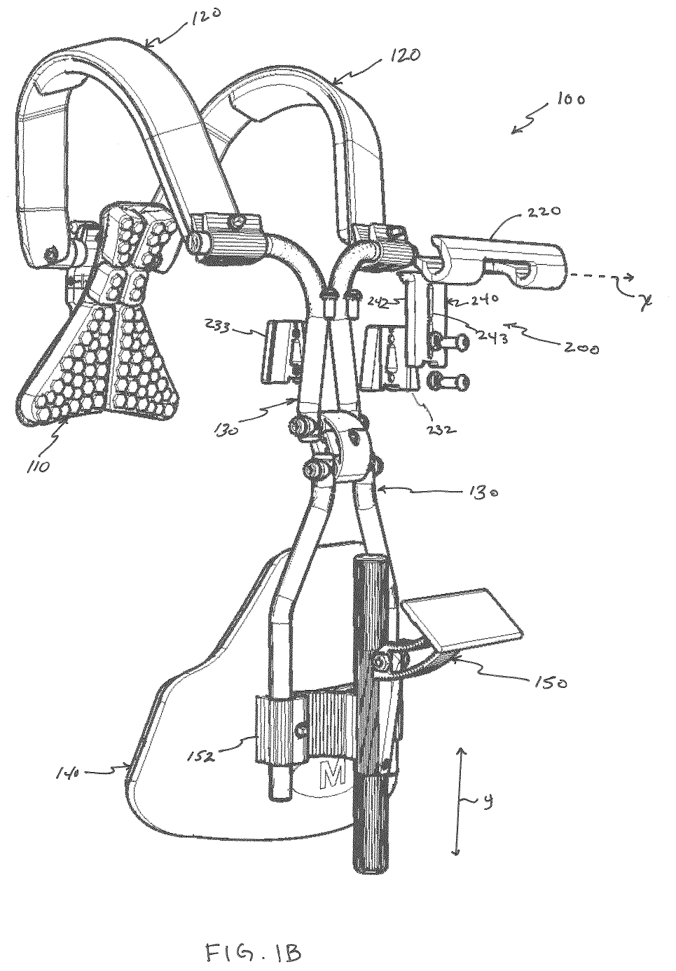

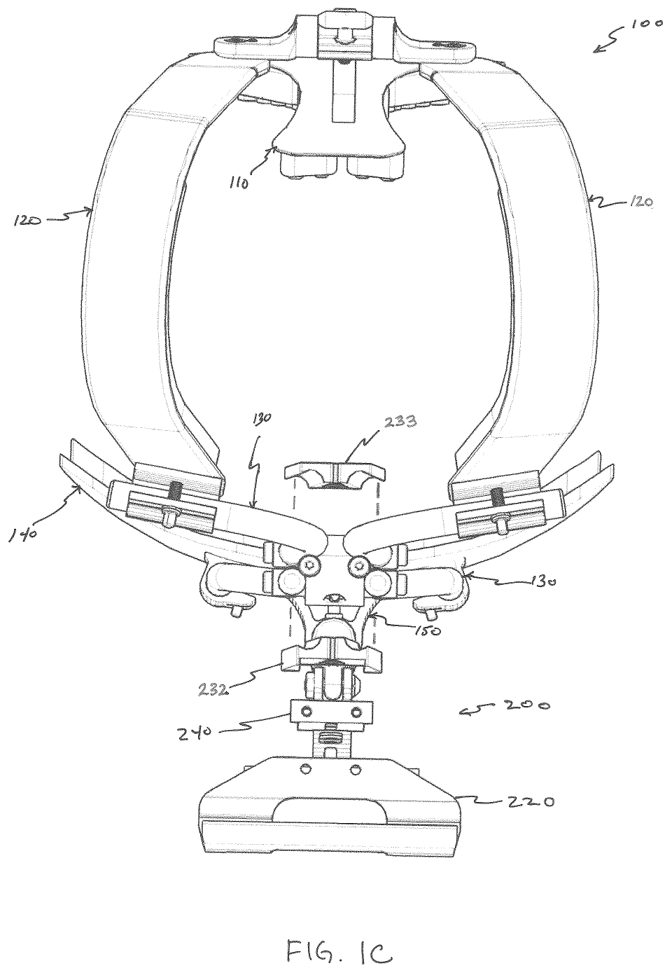

FIGS. 1-3 illustrate an exemplary carrier 100 with a saddle attachment system 200 in accordance with one or more embodiments.

In general, the carrier 100 is a user-wearable structure that functions to support an instrument 300 (e.g., a bass drum or other marching band instrument) on a user's shoulders such that the instrument 300 is positioned for playing by the user. The carrier 100 can be any user-wearable structure that functions to support the instrument 300 on a user's shoulders such that the instrument 300 is positioned for playing by the user. Exemplary carriers and components thereof are described in at least the following: U.S. Pat. No. 7,326,842, filed on Dec. 23, 2004; U.S. Pat. No. 7,810,684, filed on Feb. 24, 2005; U.S. Pat. No. 7,394,008, filed on Apr. 22, 2005; U.S. Pat. No. 7,673,776, filed on Sep. 27, 2004; U.S. Pat. No. 7,166,790, filed on Nov. 6, 2006; U.S. Pat. No. 6,881,886, filed on Apr. 23, 2004; U.S. Pat. No. 7,420,110 filed on Dec. 23, 2004; U.S. Pat. No. 8,646,666, filed on Aug. 18, 2007; and U.S. Pat. No. 9,858,908, filed on Jan. 20, 2016, the entire disclosures of which are incorporated herein by reference.

In some embodiments, the carrier 100 comprises: a back member 110, a pair of shoulder supports 120, a frame 130, a belly member 140, and an instrument support structure 150. The back member 110 may connect the shoulder supports 120 at the user's back. The frame may connect the shoulder supports 120 as the user's front and may extend therefrom to the belly member 140 on which the instrument support structure 150 may be mounted. Accordingly, in operation, the shoulder supports 120 may rest on the user's shoulders and thereby support the weight of the instrument 300 that in-turn rests at least partially on the instrument support structure 150.

The instrument support structure 150 may include a mounting member 152 mounted to the belly member 140 and coupled to a support member 154 configured to receive the instrument 300 for resting thereon (e.g., via a platform or some other structure). Accordingly, the instrument support structure 150 supports the instrument 300 from underneath. The support member 154 may also be coupled to the mounting member 152 so as to be vertically adjustable relative to the mounting member 152—i.e., substantially along a y-axis. Accordingly, vertical adjustment of the support member 154 may function to adjust the playing position of the instrument 300.

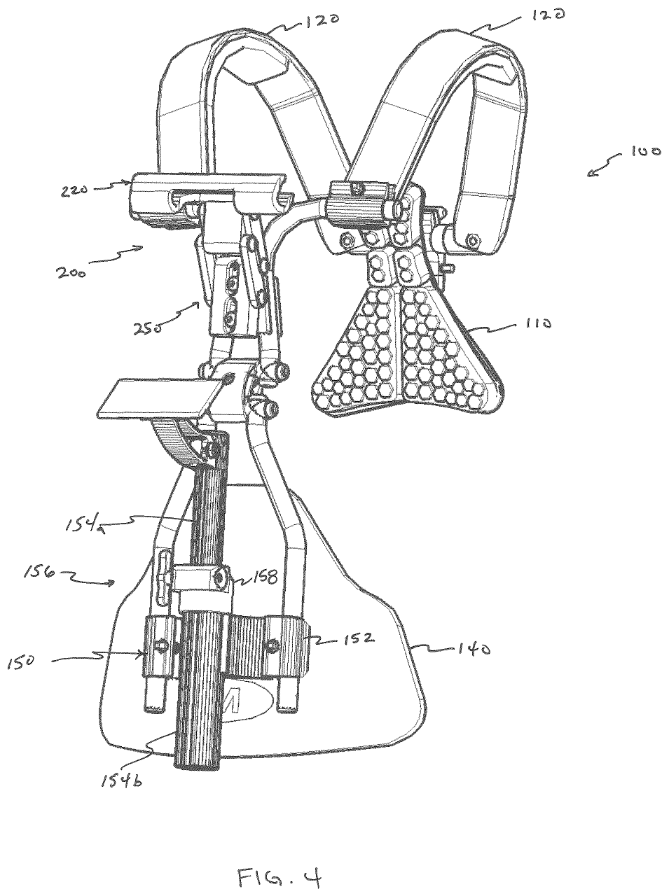

In some embodiments (e.g., FIG. 4) the vertical adjustment may be via a mechanical assist 156. The mechanical assist 156 may comprise a gas spring that is housed internally to telescoping support members 154a, 154b. A first telescoping support member 154b may be coupled to the mounting member 152, and a second telescoping support member 154a may be telescopically engaged within the first telescoping support member 154b. The internally housed gas spring may provide the mechanical assistance force to extend the second telescoping support member 154a from the first telescoping support member 154b.

In addition, the relative vertical position of the first telescoping support member 154b with respect to the mounting member 152 may be adjustable, in particular, manually adjustable. Accordingly, in some embodiments, the first telescoping support member 154b is coupled to the mounting member 152 so as to be vertically adjustable relative to the mounting member 152—i.e., substantially along a y-axis—in addition to the vertical adjustment provided by the mechanical assist 156. Accordingly, a two-stage vertical adjustment of the support member 154 may function to adjust the playing position of the instrument 300.

A joint lock assembly 158 may be provided and configured to lock the relative positions of the telescoping support member 154. Further exemplary mechanical assists are described in at least U.S. Pat. No. 10,167,994 filed on Nov. 29, 2017; U.S. Pat. No. 7,703,725 filed on Oct. 31, 2005; U.S. Pat. No. 7,718,878 filed on Sep. 12, 2008; and U.S. Pat. No. 7,438,266 filed on Jun. 9, 2006, the entire disclosures of which are herein incorporated by reference.

In general, the saddle attachment system 200 is configured to be mounted to the carrier 100 such that, when so mounted, the saddle attachment system 200 functions to receive a grip 310 of the instrument 300 therein. This allows for free on-demand instrument rotation positioning adjustment while restricting lateral movement, which eliminates the need for ancially mechanical locking/unlocking mechanism securing the bass drum from mechanical backlash, and lateral sidelash during performing. The saddle attachment system 200 therefore forms an upper anchor point coupling the instrument 300 to the carrier 100. In some embodiments, the saddle attachment system 200 may be configured such that the instrument 300 is rotatable about an x-axis of the upper anchor point, whereby vertical adjustment of the support member 154 functions to rotationally adjust the playing position of the instrument 300.

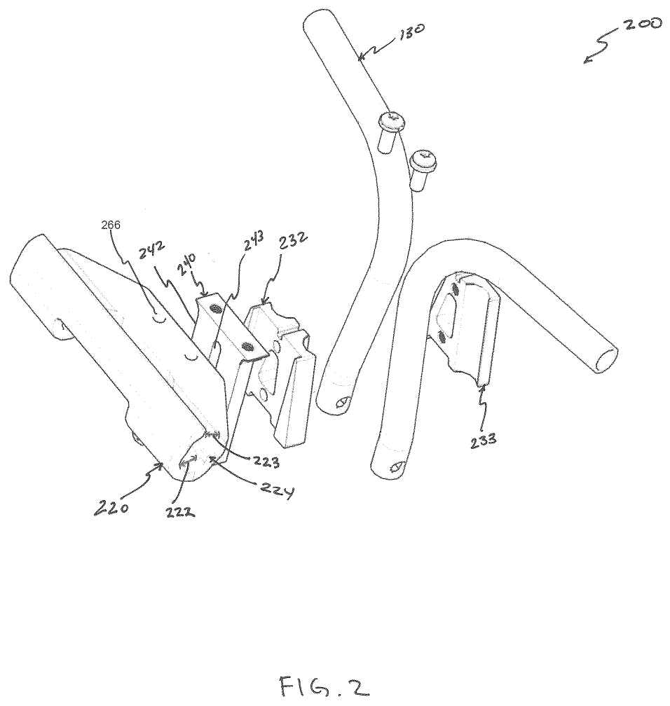

FIG. 2 illustrates the saddle attachment system 200 in accordance with at least one embodiment.

The saddle attachment system 200 comprises a receiver 220 that is generally configured to receive the grip 310 of the instrument 300 therein in gravity assisted drop-in manner. In other words, in operation, the grip 310 of the instrument 300 may be positioned over the receiver and thereafter be allowed to drop by gravity into the receiver 220 so as to thereby be caught by the receiver 220 and maintained therein. Accordingly, the receiver 220 may be shaped so as to permit the drop-in reception of the grip 310.

In some embodiments, the receiver 220 may be an elongated semi-tube, as shown in FIGS. 1 and 2, and the grip 310 may be a tube or rod bridge 310 comprising a rod or tube 312 suspended between opposing mounts 314 that are in-turn mounted to the instrument 300 (e.g., a bass drum). An exemplary tube bridge is described in U.S. patent application Ser. No. 17/985,503. Accordingly, the semi-tube receiver 220 may have a tube radius 222 and an opening width 223 that are sized so as to closely mate with the tube 312 of the tube bridge 310 and thereby allow for the aforementioned rotation of the instrument 300 without undue lateral movement. In some embodiments, the receiver 220 also includes an inner ledge 224 that allows for a greater opening width while maintaining the closely mating tube radius. In at least one embodiment, the saddle attachment system 200 includes the grip 310 configured to be retrofit to the instrument 300. In some embodiments, the grip 310 also provides a handle for transporting the instrument 300 when not engaged with the saddle.

The receiver 220 may also include a catch-lock or snap-lock cam mechanism (not shown). The catch-lock/snap-lock mechanism permits highly acrobatic movements of the bass drum during performance, including the generation of simultaneous, rapid spinning, forward and backward bending movements of the performer Exemplary catch-lock mechanisms are described in U.S. patent application Ser. No. 17/985,503, the entire disclosure of which is herein incorporated by reference. In general, the catch-lock mechanism may include one or more cam-locks that are rotatable about the x-axis (or an axis parallel thereto) such that, when the grip 310 is placed or otherwise dropped into the receiver 220, the cam-locks are actuated to rotate about the x-axis to close over the grip 310. The catch-lock mechanism thereby secures the grip 310 within the receiver 220. Alternatively, or additionally, the cam-locks may be manually rotated to close (and likewise to open in a counter-rotation movement) without the need for external tools.

As shown in FIG. 1, the saddle attachment system 200 also includes a saddle mount 230 configured to mount the receiver 220 to the carrier 100. In some embodiments, the saddle mount 230 is configured to mount the receiver 220 to the frame of the carrier 100. However, the saddle mount 230 may mount the receiver 220 to any portion of the carrier 100. Accordingly, the receiver 220 may be removably or integrally coupled to the saddle mount 230, directly or indirectly.

In at least one embodiment, the saddle mount 230 comprises mating jaw plates 232, 233 configured to secure to the frame via clamping. An exemplary clamping is shown in FIGS. 1A-C. Accordingly, the jaw plates 232, 233 may be half-plates of a double c-clamp that receive therein tubes of the frame—and when tightened together (e.g., via screws or other fasteners) secure the saddle mount 230 to the frame via friction.

In some embodiments, the saddle attachment system 200 also includes an adjustment riser 240. The adjustment riser 240 is generally configured to enable vertical adjustment of the receiver 220 with respect to the saddle mount 230—and consequently with respect to the carrier 100. Accordingly, the adjustment riser 240 may couple the receiver 220 to the saddle mount 230.

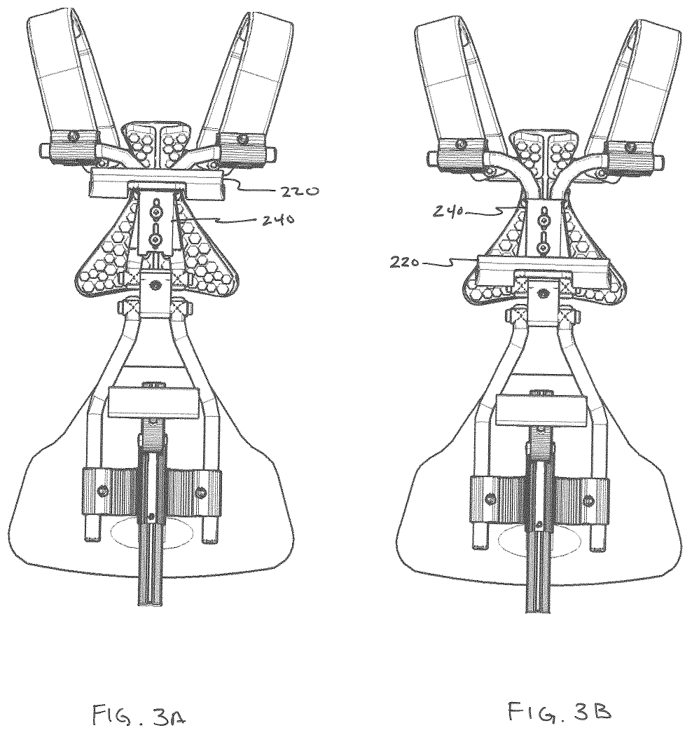

In at least one embodiment, the adjustment riser 240 comprises: a riser plate 242 having a vertical slot 243 therethrough. The riser plate 242 is configured to attach to the receiver 220 at either vertical end of the riser plate 242, as shown in FIGS. 3A-3B. The riser plate 242 is also configured to be coupled to the saddle mount 230 via the slot so as to be vertically adjustable with respect to the saddle mount 230. Accordingly, one or more fasteners may be utilized that extend through the slot to the saddle mount 230. In some embodiments, the fasteners also extend through the jaw plates 232, 233 so as to also clamp the saddle mount 230 to the frame.

As shown in FIG. 2, in some embodiments, the riser plate 242 is also generally configured to enable a forward/backward horizontal adjustment of the receiver 220 with respect to the riser plate 242—and consequently with respect to the carrier 100. Accordingly, the receiver 220 may further comprise one or more horizontal slots 266 therethrough. The receiver may be configured to be coupled to the riser plate 242 via the horizontal slots so as to be horizontally adjustable with respect to the riser plate 242. In particular, one or more fasteners may be utilized that extend through each horizontal slot to the riser plate 242.

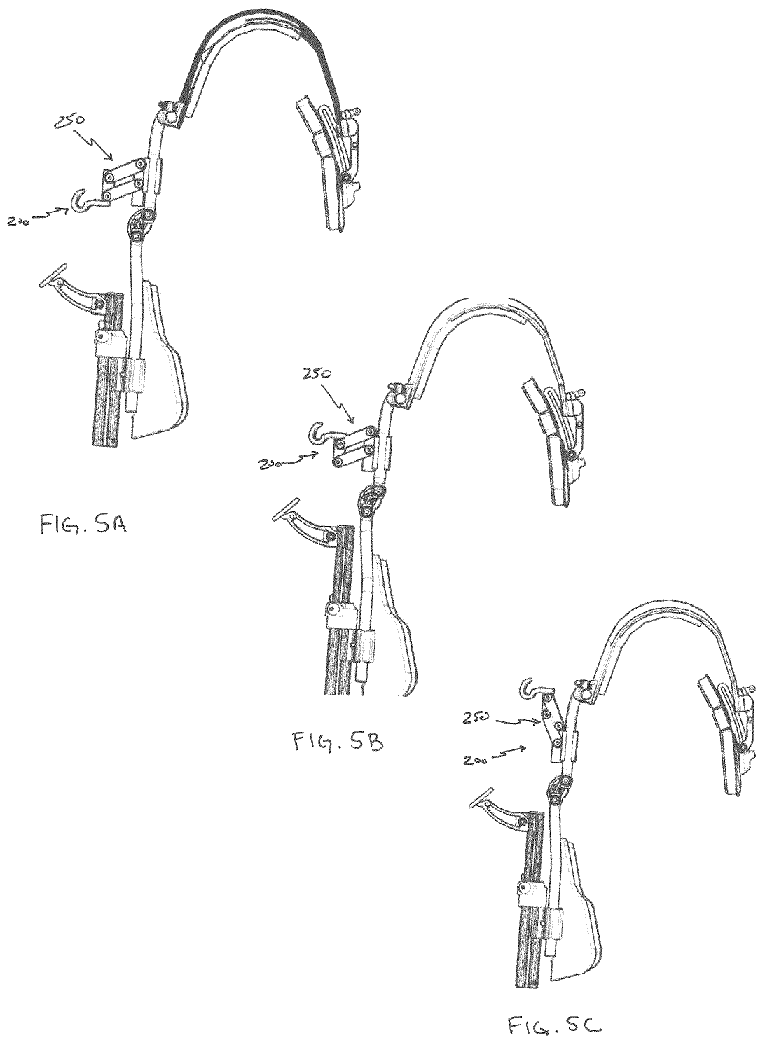

FIGS. 4-6 illustrate the exemplary carrier 100 with the saddle attachment system 200 comprising an articulating member 250 configured to couple the receiver 220 to the saddle mount 230 directly (or indirectly via the adjustment riser 240) in accordance with at least one embodiment. The articulating member 250 is generally configured to enable the receiver 220 to move along a radial arc with respect to the saddle mount 230, as shown in FIGS. 5A-C, for example. Accordingly, the articulating member 250 may comprise a double-hinge structure.

In at least one embodiment, the articulating member 250 comprises: a receiver block 252, hinge arms 254, clamp axle bolts 256, and clamp axle bolt housing 258, 259.

The receiver block 252 is coupled to the receiver 220 at either vertical end of the receiver block 252. The receiver block 252 is also coupled to the hinge arms 254 via axle bolts 255, which are in turn coupled to the clamp axle bolt housing 258, 259 via the clamp axle bolts 255, such that the receiver block 252 is articulatable with respect to the clamp axle bolt housing 258, 259.

The hinge arms 254 have non-circular openings 257 configured to receive the clamp axle bolts 255 such that the clamp axle bolts 255 do not rotate relative to the hinge arms 254, but that when not restricted by friction (as detailed below) allow the hinge arms 254 to rotate relative to the clamp axle bolt housing 258, 259. The clamp axle bolt housing 258, 259 in turn is configured to engage the clamp axle bolts 255 in a sandwich like manner so as to provide, on tightening, frictional force that resists the articulation of the hinge arms 254. On the other hand, upon loosening, the frictional force may be lessened so that articulation of the hinge arms 254 may be had. Such tightening and loosening may be provided by a screw or other such means. Accordingly, the articulating member 250 enables the receiver 220 to articulate with respect to the saddle mount 230.

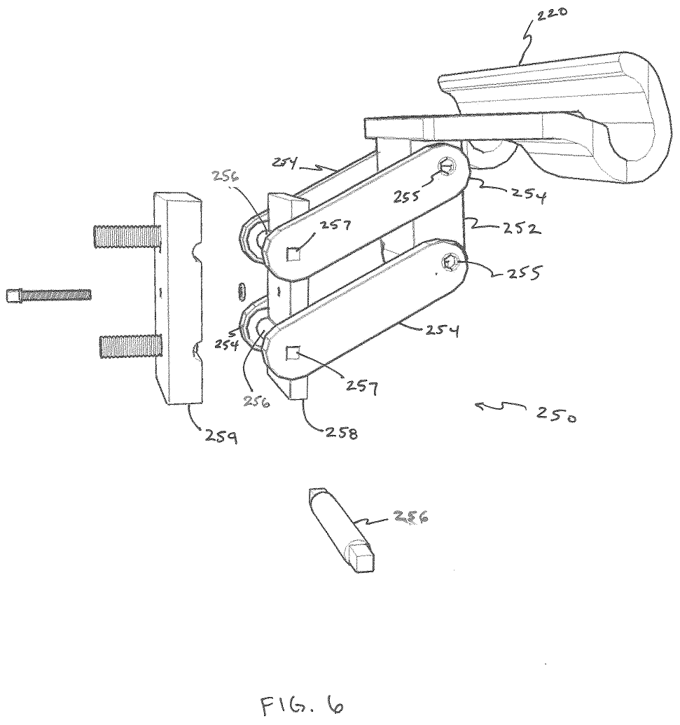

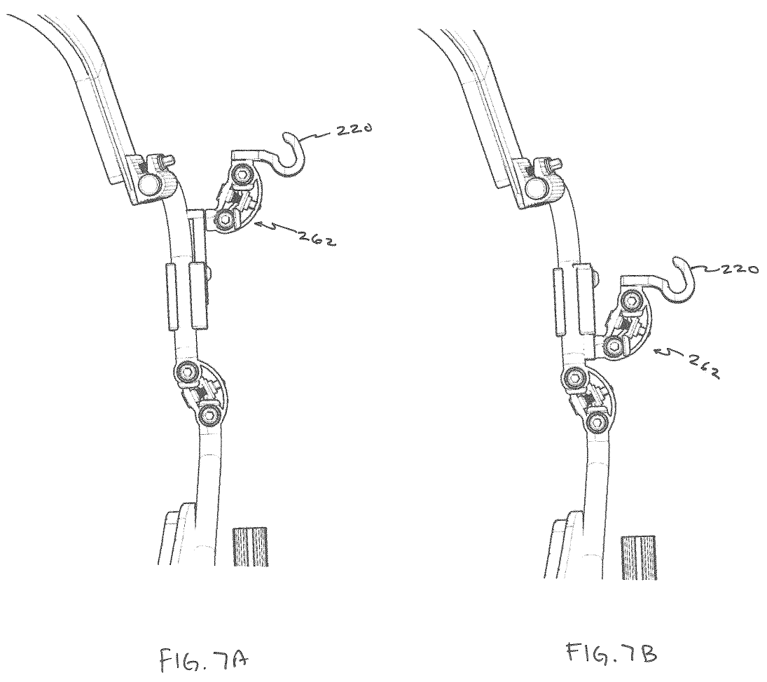

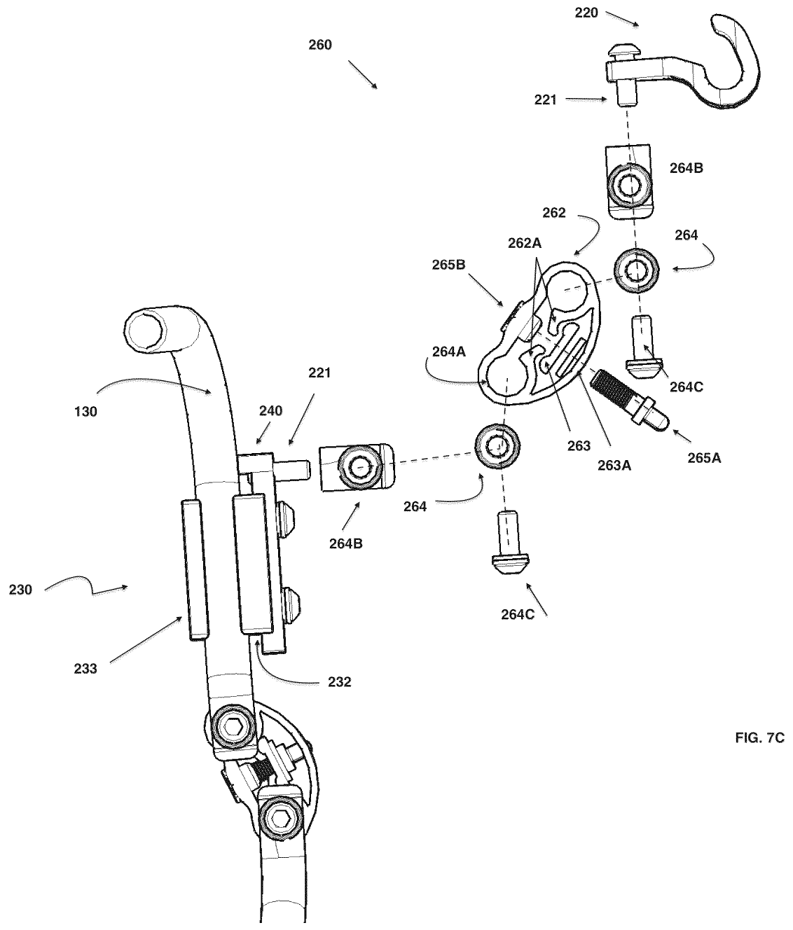

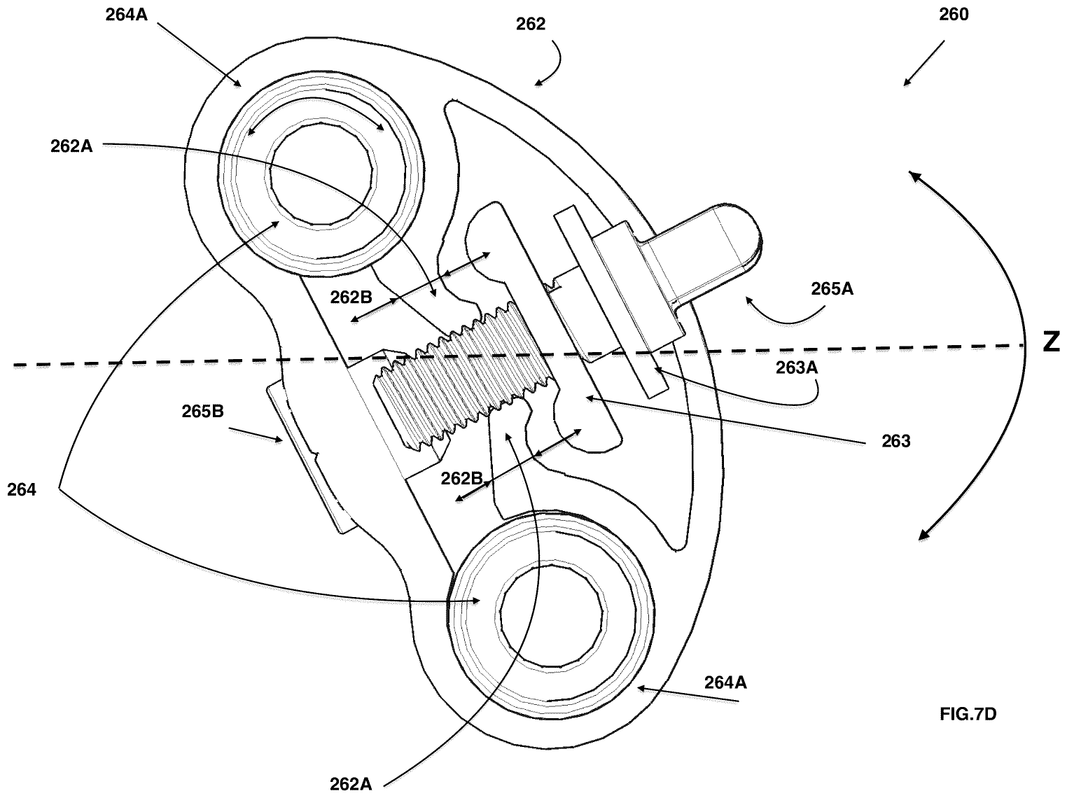

FIG. 7A-D illustrates a multi-hinge articulating member 260 according to at least one embodiment. The mechanical and functional principles are similar to the articulating member 250. The differences will be apparent to those of ordinary skill in the art from the related figures and descriptions herein.

The multi-hinge articulating member 260 comprises a housing 262 with integrated circumferential axle pockets 264A that are configured to receive axles 264 therein. The axle pockets 264A each comprise a partial circumference configured to engage the periphery of the axle received therein, except for at an opening 262B adjacent to which integrated closure tabs 262A extend from the circumference of the axle pockets 264A. The axles 264 may have fish mouth ends (not shown) that interconnect with tube/rod or block 264B mounting studs via fastener 264C. The mounting stud/s 264B (upper) may interconnect with receiver 220 and 264B (lower) interconnect with saddle mount 230 via fasteners 221. FIGS. 7A-B also illustrate reversing or inverting riser plate 242 for additional vertical positioning. Accordingly, the multi-hinge articulating member 260 is articulatable, relative to the receiver 220 and the saddle mount 230, along path Z.

The axle pockets 264A are configured such that a closing force applied to the closure tab 262A in the direction of the opening 262B causes the axel pocket 264A to clamp and thereby secure the axle 264 therein. The multi-hinge articulating member 260 may therefore also comprise a closing mechanism, which may include a threaded member 265A that threads into the housing 262 at base 265B. The closing mechanism may further include a block washer 263 & washer 263A. In operation, when the threaded member 265A is tightened via screw-in motion, the block washer block washer 263 & washer 263A is thereby driven to contact the closure tabs closure tab 262A (preferably in a mating geometry) and exert the closing force thereon. Thus, the closing mechanism provides the closing force lineally to cause the axle pockets 264A to clamp onto the axles 264. The axles 264 are thereby, through the resulting frictional force, prevented from rotating-which locks the relative angular positioning of the multi-hinge articulating member 260 with respect to the receiver 220 and the saddle mount 230.

In at least one embodiment, the housing 262 is constructed at least partially of light weight material that allows for the axle pockets 264A to elastically flex under the closing force, so as to thereby clamp onto the axles 264—and to elastically return to an un-flexed position when the closing force is reduced and/or released. Such light weight material may be, for example: plastic, aluminum and/or magnesium alloys. Exemplary carriers and components of alternate embodiment/s featuring multi-hinged carriers are described in at least the following: U.S. Pat. Nos. 7/166,790, 6/323,407, the entire disclosures which are incorporated herein by reference.

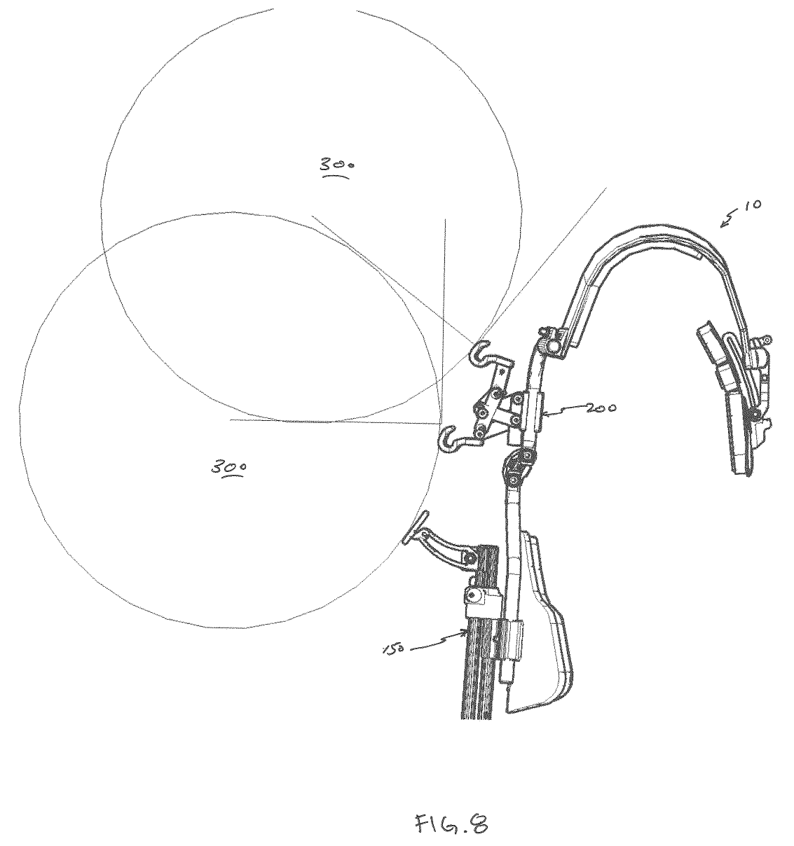

In operation, the systems and devices described herein allow for easier and more effective positioning of the instrument 300 with respect to the carrier 100 (and by extension the user). More particularly, the embodiments described herein allow the user to more easily mount and un-mount the instrument 300, as well as more easily elevate, lower and otherwise reposition the instrument 300 (FIG. 8). Accordingly, assistance from other individuals is reduced or rendered unnecessary—providing for an increased variety of adjustments that can be made quickly during performances for visual and/or sound quality effect. In addition, when combined with the percussion instrument stand (such as the stand described in U.S. patent application Ser. No. 17/985,503), the systems and devices described herein allow for further ease of transitioning between an instrument-on-carrier state and an instrument-on-stand state.

The features described above are considered novel over the prior art of record and are considered critical to the operation of at least one aspect of the invention and to the achievement of the objectives of the invention. The words used in this specification to describe the exemplary embodiments are to be understood not only in the sense of their commonly defined meanings, but also to include any special definition with regard to structure, material or acts that would be understood by one of ordinary skilled in the art to apply in the context of the entire disclosure.

The definitions of the words or drawing elements described herein are meant to include not only the combination of elements which are literally set forth, but all equivalent structures, materials or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim without departing from the scope of the invention.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

What is claimed is:

1. A system, comprising:
a percussion instrument mounted grip; and
a saddle attachment mechanism that is mountable to a percussion instrument carrier at a front side thereof and between shoulder straps and a belly plate thereof so as to form an upper anchor point,
wherein the saddle attachment mechanism is configured to receive the grip therein so as to thereby couple the percussion instrument to the carrier such that the percussion instrument is rotatable about an x-axis of the upper anchor point and rests on a support member of the percussion instrument carrier, and
wherein vertical adjustment of the support member rotationally adjusts the playing position of the percussion instrument about the x-axis of the upper anchor point.

2. The system of claim 1, wherein the system further comprises the percussion instrument carrier.

3. The system of claim 1, wherein the saddle attachment mechanism comprises:
a receiver configured to receive the grip therein via a drop-in action.

4. The system of claim 3,
wherein the receiver is formed as a semi-tube elongated along the x-axis with a longitudinal slot opening extending the length thereof, and
wherein the grip is formed as a tubular bridge elongated along the x-axis.

5. The system of claim 3, wherein the receiver includes an inner ledge forming a double-bump-curve with the semi-tube at the slot opening.

6. The system of claim 3, wherein the saddle attachment mechanism further comprises:
a saddle mount configured to mount the receiver to the carrier.

7. The system of claim 6, wherein the saddle mount comprises:
a pair of mating jaw plates configured to secure the receiver to a frame of the instrument carrier via clamping.

8. The system of claim 6, wherein the saddle mount comprises:
an adjustment riser configured to vertically reposition the receiver with respect to the saddle mount.

9. The system of claim 6, wherein the saddle attachment mechanism further comprises:
an articulating member configured to articulate in a double-hinge action so as to reposition the receiver along a radial arc with respect to the saddle mount.

10. The system of claim 1, wherein the support member includes a mechanical assist configured to vertically adjust the support member relative to the belly plate.

11. A saddle attachment mechanism for a percussion instrument carrier, the saddle attachment mechanism comprising:
a saddle mount configured to mount the saddle attachment mechanism to the percussion instrument carrier at a front side and above a belly plate thereof so as to form an upper anchor point; and
a receiver coupled to the saddle mount, wherein the receiver is configured to receive a percussion instrument mounted grip therein so as to thereby couple the percussion instrument to the carrier such that the percussion instrument is rotatable about an x-axis of the upper anchor point and rests on a support member of the percussion instrument carrier,
wherein vertical adjustment of the support member rotationally adjusts the playing position of the percussion instrument about the x-axis of the upper anchor point.

12. The saddle attachment mechanism of claim 11, wherein the receiver is configured to receive the grip therein via a drop-in action.

13. The saddle attachment mechanism of claim 11,
wherein the receiver is formed as a semi-tube elongated along the x-axis with a longitudinal slot opening extending the length thereof, and
wherein the grip is formed as a tubular bridge elongated along the x-axis.

14. The saddle attachment mechanism of claim 11, wherein the receiver includes an inner ledge forming a double-bump-curve with the semi-tube at the slot opening.

15. The saddle attachment mechanism of claim 11, wherein the saddle mount comprises:
a pair of mating jaw plates configured to secure the receiver to a frame of the instrument carrier via clamping.

16. The saddle attachment mechanism of claim 15, wherein the saddle mount comprises:
an adjustment riser configured to vertically reposition the receiver with respect to the saddle mount.

17. The saddle attachment mechanism of claim 15, wherein the saddle attachment mechanism further comprises:
an articulating member configured to articulate in a double-hinge action so as to reposition the receiver along a radial arc with respect to the saddle mount.

18. The system of claim 11, wherein the support member includes a mechanical assist configured to vertically adjust the support member relative to the belly plate.
